(19) United States
(12) Patent Application Publication
(10) Pub. No.: US 2025/0148351 A1
(43) Pub. Date: May 8, 2025

(54) SYSTEM AND ARCHITECTURE FOR CONTINUOUS METALEARNING

(71) Applicant: Mind Foundry Ltd, Oxford (GB)

(72) Inventors: Francesca Garcia, London (GB); Helen McKay, Ringwood (GB); Bernardo Pérez Orozco, London (GB); Davide Zilli, Oxford (GB); Joanna Crown, Oxford (GB); William Parr, Bristol (GB); Brian Mullins, Oxford (GB); Michael Osborne, Oxford (GB); Stephen Roberts, Shipton-on-Cherwell (GB); Alistair Garfoot, Oxford (GB); Nicholas Sherman, Oxford (GB); Adam James, Ashford Hill (GB)

(21) Appl. No.: 18/501,521

(22) Filed: Nov. 3, 2023

(51) Int. Cl. G06N 20/00

(52) U.S. Cl. CPC G06N 20/00

(57) ABSTRACT

A continuous meta-learning system operating at a server is described. In one aspect, a computer-implemented method includes accessing, at the server, a deployed machine learning model, metadata, and new prediction data for the deployed machine learning model, detecting a novel trend in the deployed machine learning model based on the new prediction data, generating label suggestions for the novel trend using metadata, querying a plurality of users to verify the label suggestions, detecting a consensus of the plurality of users, the consensus based on a rate of responses from the plurality of users that confirm the label suggestions, and in response to detecting the consensus, training a new machine learning model based on the new prediction data and the consensus of the plurality of users. The computer-implemented method also includes deploying the new machine learning model at the server.

### TECHNICAL FIELD

The subject matter disclosed herein generally relates to methods, systems, and programs for a machine learning platform. Specifically, the present disclosure addresses systems, methods, and computer programs for continuous metalearning.

### BACKGROUND

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data. However, those models can drift over time.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 illustrates a continuous metalearning system in accordance with one example embodiment.

FIG. 3 illustrates a drift detection system in accordance with one example embodiment.

FIG. 4 illustrates a human-AI collaboration system in accordance with one embodiment.

FIG. 5 illustrates an automated monitoring system in accordance with one example embodiment.

FIG. 6 illustrates a multi-agent system in accordance with one example embodiment.

FIG. 7 illustrates a machine learning platform in accordance with one example embodiment.

FIG. 8 illustrates a model trainer in accordance with one example embodiment.

FIG. 9 illustrates a model optimization system in accordance with one example embodiment.

FIG. 10 illustrates a method for training a model for continuous meta-learning in accordance with one example embodiment.

FIG. 11 is block diagram showing a software architecture within which the present disclosure may be implemented, according to an example embodiment.

FIG. 12 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural Components, such as modules) are optional and may be combined or subdivided, and operations (e.g., in a procedure, algorithm, or other function) may vary in sequence or be combined or subdivided.

MLOps (Machine Learning Operations) are becoming more important due to the increased use of Artificial Intelligence. MLOps is a practice focused on how to manage learning models in the ‘wild’ (e.g., real-world) and ensuring that the deployed learning model(s) continue behaving as intended. Without robust MLOps practices, machine learning models run the risk of not delivering on performance over time.

For example, model drift refers to a phenomenon where the statistical properties of the data being predicted by a machine learning model change over time, causing the performance of the model to deteriorate. This can happen for a number of reasons, such as changes in the distribution of the input data over time or the relationship between the input and the desired target changing. Drift can be a major problem when machine learning is used in the real world, where data is often dynamic and always changing.

There are two main types of drift: concept drift and data drift. Concept drift occurs when the task that the model was designed to perform changes over time. For example, if the types of spam emails that people receive change significantly, the model may no longer be able to accurately detect spam. Data drift occurs when the distribution of the input data changes over time, but the task remains the same. For example, if the demographics of loan applicants change over time, the model may not be able to accurately assess their risk.

Some examples of overcoming model drift include:
Monitoring the model performance and data quality regularly and alerting when anomalies are detected.
Updating or retraining the model with new data periodically or when significant drift is detected.
Using online or adaptive learning methods that can update the model parameters continuously or incrementally with new data.
Using robust or flexible models that can handle changes in the data better than rigid or overfitted models.

The monitoring of model performance and data quality can be performed via MLOps platforms that offer dashboards for data scientists or research scientists such that they can view, diagnose, and then be able to make a decision on how to rectify performance issues (e.g., data drifting). The platforms offer methods of monitoring the changes. However, these platforms do little to increase ‘knowledge base’ and ‘understanding’ the AI system has of the world, as the picture of reality (and subsequent data inputs to the model) change. The industry standard also typically does not have any specified workflow or method for human domain experts to continually input their knowledge into the system.

The present application describes a platform that automatically identifies any imminent issues, before performance degrades, and will automatically rectify them where possible, and/or query the expert user (or a group of users) of the system (e.g., an insurance underwriter, who uses the system) to label data points that might be ‘drifting’.

In addition, the AI system uses either drifted data points, or new clusters, to pick up novel trends that the model had previously not seen before. This is verified using a consensus system from domain expert labelers, such that the model evolves in a correct direction using ground truth evaluation.

By opting for a human-AI collaboration approach, the model will only re-train once it is verified (by humans) that what the model has picked up is true. This allows the deployment of multi-agent systems to perform related, yet distinct tasks, and to augment the overall performance of the initial task of the AI system.

The presently-described continuous meta-learning platform for a deployed machine learning model is based on:
model identity management: this includes versioning, lineage, provenance and origins of a model
model monitoring: this includes monitoring for drift detection, anomaly detection, outlier detection, as well as being able to compare the latest predictions of the model against some specified fairness and bias metrics.
model improvement, through meta-learning: this includes transfer learning and the creation of multi-agent systems, as well as active learning, which focuses on the optimization of selection of data points to be labelled.

The following example illustrates a use case scenario of how the presently described continuous meta-learning system can be used to detect data drift and pick up on new trends. For example, in the context of an auto insurance AI system, telematics data is used to assess driver behavior. The model has been trained to specifically detect delivery driving behavior. Detecting this behavior is important, as delivery driving can be in breach of the policyholder agreements. There might be other behaviors that are in breach of policy and important to the insurer. However, the model deployed in a traditional MLOps system does not pick up on these new behaviors. The traditional solution just ensures the performance of detecting delivery driving remains within certain thresholds, by monitoring data drifts.

The presently described continuous meta-learning system not only monitors the performance of the delivery driving segment, but also identifies new segments that would be of interest to the insurer (e.g., for example: taxi driving or mobile hairdressing). The AI system and the continuous meta-learning system are therefore able to pick up on new trends and behaviors, without being explicitly trained on those classes. The new trend/behavior is further dynamically verified by the domain expert to avoid machine learning system errors.

In addition, the presently described continuous meta-learning system includes extensive model versioning, lineage and provenance, such that the insurer can restore or revisit previous model versions should the insurer, for example, change its policyholder agreements.

One aspect of the proposed continuous meta-learning system is its tight integration of human expertise into the machine learning process. Rather than just monitoring model performance, it actively queries domain experts to validate new trends and labels detected by the models. It uses a consensus system to aggregate multiple human perspectives, ensuring the model evolves in the right direction based on ground truth evaluation. Tying the transfer learning and model retraining directly to human confirmation of the model's new insights helps overcome issues like concept drift or uncertainty in a novel way.

Another feature is the multi-agent framework that allows seamless collaboration between human users and AI agents. The agents can provide feedback to each other-humans verifying model behaviors, models suggesting new trends to humans. This facilitates richer interaction beyond just unilateral model performance monitoring. The collaborative multi-agent system also enables efficient transfer learning, allowing models to be deployed to adjacent users working on related problems once validated.

The combination of leveraging human expertise to guide model adaptation, collaborative multi-agent interaction, and transfer learning to propagate new knowledge, represents a novel approach to continuous meta-learning and more robust MLOps. The human-centric consensus system for ground truth evaluation is not found in traditional continuous learning techniques.

In one example embodiment, a continuous meta-learning system operating at a server is described. In one aspect, a computer-implemented method includes accessing, at the server, a deployed machine learning model, metadata, and new prediction data for the deployed machine learning model, detecting a novel trend in the deployed machine learning model based on the new prediction data, generating label suggestions for the novel trend using metadata, querying a plurality of users to verify the label suggestions, detecting a consensus of the plurality of users, the consensus based on a rate of responses from the plurality of users that confirm the label suggestions, and in response to detecting the consensus, training a new machine learning model based on the new prediction data and the consensus of the plurality of users. The computer-implemented method also includes deploying the new machine learning model at the server.

As a result, one or more of the methodologies described herein facilitate solving the technical problem of model drift with limited resources. As such, one or more of the methodologies described herein may obviate a need for certain efforts or computing resources that otherwise would be involved in using machine learning platforms. As a result, resources used by one or more machines, databases, or devices (e.g., within the environment) may be reduced. Examples of such computing resources include Processor cycles, network traffic, memory usage, data storage capacity, power consumption, network bandwidth, and cooling capacity.

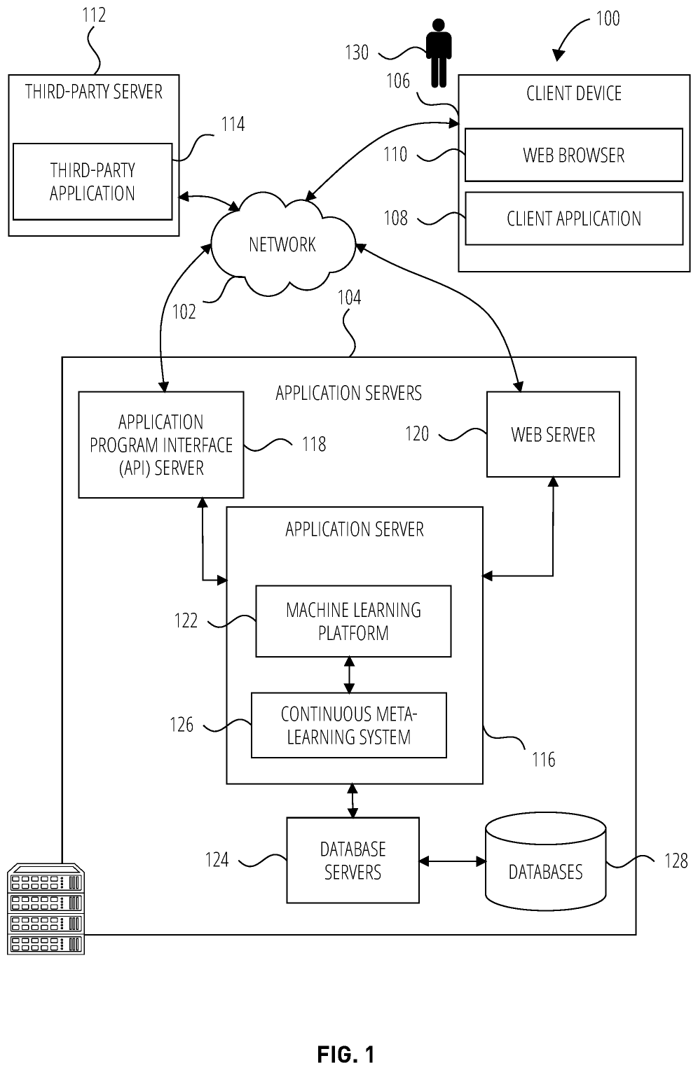

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106. A web browser 110 (e.g., a browser) and a client application 108 (e.g., an “app”) are hosted and execute on the web browser 110. A user 130 operates client device 106.

An Application Program Interface (API) server 118 and a web server 120 provide respective programmatic and web interfaces to application servers 104. A specific application server 116 hosts a machine learning platform 122 (which includes Components, modules and/or applications) and a continuous meta-learning system 126. FIG. 1 illustrates an embodiment where the continuous meta-learning system 126 is external to the machine learning platform 122. In another example embodiment, the continuous meta-learning system 126 is part of the machine learning platform 122.

The machine learning platform 122 receives training data from the client device 106, the third-party server 112, and/or the continuous meta-learning system 126. The machine learning platform 122 generates a machine learning model based on the training data. The machine learning platform 122 deploys the machine learning model and monitors a performance (e.g., accuracy) of the machine learning model. In another example, a combination of the machine learning platform 122 and the continuous meta-learning system 126 monitor the performance of the deployed machine learning model. In some example embodiments, the machine learning platform 122 includes machine-learning programs (MLPs), also referred to as machine-learning algorithms or tools, that are utilized to perform operations associated with, for example, predicting a value of an item at a future point in time, solving values of a target column, or discovering features of training data.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a machine learning model from training data in order to make data-driven predictions or decisions expressed as outputs. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying attributes of the training data or identifying patterns in the training data.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, machine learning algorithms identify patterns of significance in relation to other attributes in the training data. These algorithms utilize this training data to model such similar relations that might affect a predictive outcome.

The machine learning platform 122 includes a programmatic application accessed by the client device 106. Examples of programmatic applications include a data scientist portal application, a machine learning portal application, and analysis applications. In one example, the machine learning platform 122 determines a machine learning training strategy that is used to configure an underlying learning model and to select how much training data to use. The machine learning platform 122 identifies the underlying model and the selected training data. The machine learning platform 122 trains a machine learning model based on the underlying model and the selected training data. The machine learning platform 122 and/or the continuous meta-learning system 126 monitors actual resources used by the machine learning platform 122 during training of the machine learning model.

The continuous meta-learning system 126 accesses the deployed machine learning model from machine learning platform 122. Current MLOps systems focus heavily on monitoring model performance through metrics like accuracy, data drift, etc. However, they lack capabilities to detect novel trends, adapt models, and leverage human expertise in a tight collaborative loop. The continuous meta-learning system 126 (e.g., human-AI collaboration system 206) represents a more advanced form of continuous learning and adaptation.

Central to the improvement is the consensus-based human-AI collaboration framework. Rather than just unilateral automated monitoring, it enables rich bidirectional interaction—models suggest potential new trends and behaviors to human experts, who provide contextual validation and labeling. This overcomes the limitation of models only recognizing classes they were originally trained on. The human perspective provides invaluable oversight and guidance.

Aggregating inputs from multiple domain experts to reach consensus further enhances the quality of this collaborative process. It provides a robust mechanism for resolving disagreements, uncertainties, or ambiguities. The confirmation then directly triggers transfer learning to propagate the new knowledge, unlike traditional systems that lack this tight coupling.

The multi-agent capabilities allow validated models to be efficiently deployed to adjacent users working on related problems. This propagation of new insights beyond the original use case leads to even broader improvement. The modular architecture integrates human collaboration, transfer learning, multi-agent interaction, and monitoring in an innovative way.

Overall, the continuous learning paradigm itself is enhanced to be more dynamic, responsive to change, and collaborative. The human-in-the-loop approach leverages complementary capabilities of both AI and human experts to reach a higher level of reliability, adaptability, and performance. It represents a significant advancement of MLOps and continuous learning capabilities beyond current state-of-the-art.

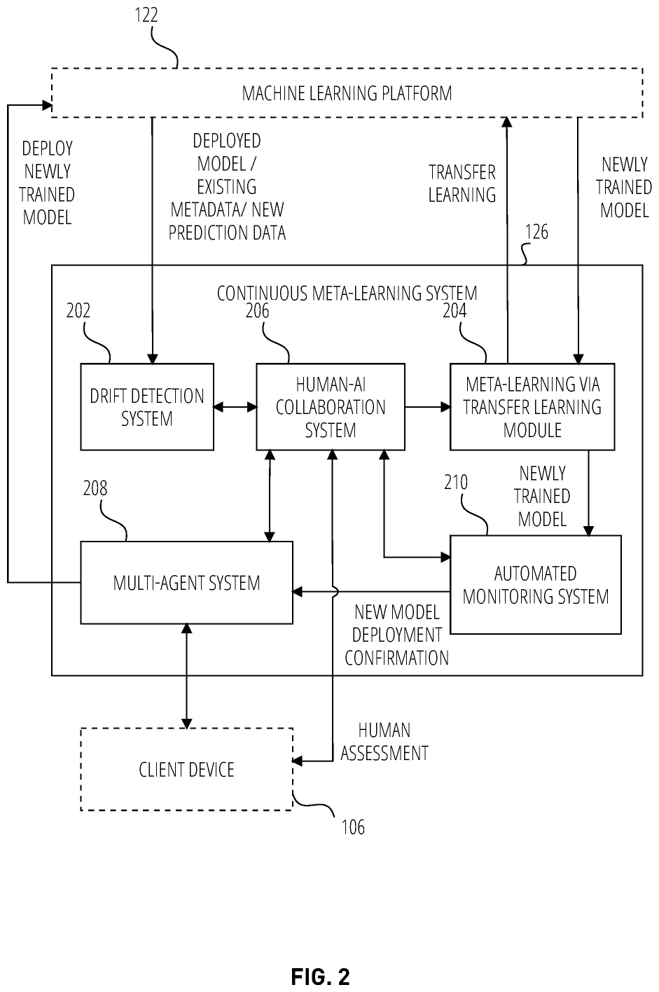

In one example embodiment, the continuous meta-learning system 126 dynamically interacts with a user (e.g., user 130) to expedite and increase its own learning capability (for example, by querying the users for validation of the new trends, querying candidate labels, confirming new labels). The continuous meta-learning system 126 identifies either drifted data points, or new clusters, to pick up novel trends that the deployed model had previously not seen before. For example, when the continuous meta-learning system 126 is unsure of a novel trend, the continuous meta-learning system 126 queries users identified as domain expert labelers. In one example, the continuous meta-learning system 126 queries a predefined number of users for verification. The continuous meta-learning system 126 uses a consensus system (e.g., majority or other predefined consensus definition) from the domain expert labelers to determine whether the model evolves in a correct direction using ground truth evaluation. The continuous meta-learning system 126 directs the machine learning platform 122 to only re-train the deployed model once human users have verified that what the model has picked up is true, and allow the deployment of multi-agent systems at the continuous meta-learning system 126 to perform related tasks, and augment the overall performance of the initial task of the AI system based on the deployed model of machine learning platform 122. The continuous meta-learning system 126 is described in more detail below with respect to FIG. 2.

The web browser 110 communicates with the machine learning platform 122 and/or the continuous meta-learning system 126 via the web interface supported by the web server 120. Similarly, the client application 108 communicates with the machine learning platform 122 and/or the continuous meta-learning system 126 via the programmatic interface provided by the Application Program Interface (API) server 118.

The application server 116 is shown to be communicatively coupled to database servers 124 that facilitates access to an information storage repository or databases 128. In an example embodiment, the databases 128 includes storage devices that store information (e.g., training dataset, resource limits configuration, model hyper-parameters, underlying models, augmented dataset, dataset marketplace, machine learning models) to be processed by the machine learning platform 122 and/or the continuous meta-learning system 126.

Additionally, a third-party application 114 executing on a third-party server 112, is shown as having programmatic access to the application server 116 via the programmatic interface provided by the Application Program Interface (API) server 118. For example, the third-party application 114, using information retrieved from the application server 116, may support one or more features or functions on a website hosted by the third party. For example, the third-party application 114 provides training functionalities/operations for the the machine learning platform 122.

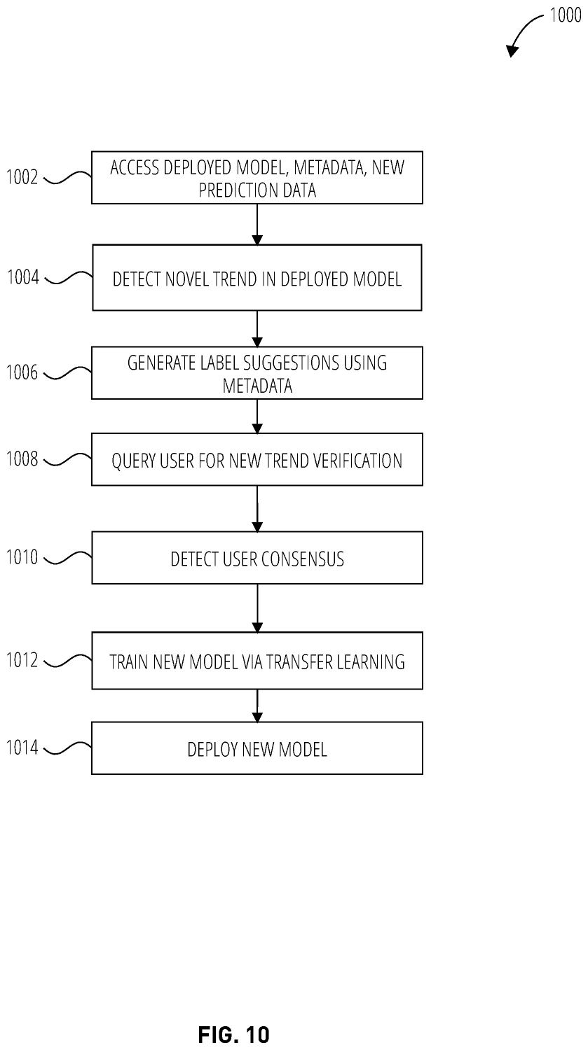

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 10, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the network environment 100. Furthermore, some Components or functions of the network environment 100 may be combined or located elsewhere in the network environment 100. For example, some of the functions of the client device 106 may be embodied at the application server 116.

FIG. 2 illustrates a continuous meta-learning system 126 in accordance with one example embodiment. The continuous meta-learning system 126 includes a drift detection system 202, a meta-learning via transfer learning module 204, a human-AI collaboration system 206, a multi-agent system 208, and an automated monitoring system 210.

The continuous meta-learning system 126 is a system that can learn to learn from data that is not segmented into discrete tasks, but rather changes over time in an unobserved way. Such a system is able to detect when the underlying task or data distribution changes and adapt its learning strategy accordingly. The continuous meta-learning system 126 can do so based on a consensus of users, who can provide feedback or guidance to the system on how to learn better.

One possible approach is to use a framework like meta-learning via online changepoint analysis (MOCA), which augments a meta-learning algorithm with a differentiable Bayesian changepoint detection scheme. The framework allows both training and testing directly on time series data without segmenting it into discrete tasks. The changepoint detection scheme can identify when the latent task switches and trigger a meta-update of the model parameters. The meta-learning algorithm can leverage past data sequences to perform well in a sequential prediction setting.

However, changepoint detection may not be sufficient or reliable in some cases, especially when the task changes are subtle or gradual. In such cases, a consensus of users can provide additional information or feedback to the system on how to learn better. For example, users can label some data points, provide hints or suggestions, vote on the best model or hyperparameters, or correct the system's mistakes. The system can then use this feedback to update its meta-knowledge and improve its learning performance.

The consensus of users can also help the system deal with issues such as noise, bias, or uncertainty in the data or the feedback. For example, users can provide confidence scores or explanations for their feedback, or the system can aggregate multiple feedback sources using techniques such as majority voting, weighted averaging, or Bayesian inference. The system can also learn to trust or distrust different users based on their past performance or reputation.

The continuous meta-learning system 126 can have many potential applications, such as:
Personalized recommender systems that can adapt to changing user preferences and contexts over time.
Adaptive educational systems that can tailor the learning content and pace to each student's needs and goals.
Self-driving cars that can learn from human drivers and road conditions and improve their safety and efficiency.
Smart home devices that can learn from user behavior and preferences and provide personalized services and suggestions.

The drift detection system 202 accesses deployed model, existing metadata, and new prediction data from the machine learning platform 122. The drift detection system 202 detects whether the deployed model has drifted based on the deployed model, existing metadata, and new prediction data. The drift detection system 202 detects drifted data points, or new clusters, and picks up novel trends that the deployed model has previously not seen before. For example, the drift detection system 202 detects a ‘novel’ trend (e.g., a trend that it has not seen before). The drift detection system 202 identifies ‘novelty’ by looking at new and emergent ‘clusters.’ The drift detection system 202 can provide a confidence score on its predictions, which might represent a novel trend, or possibly where data has drifted slightly.

In one example, the drift detection system 202 monitors the performance of the deployed machine learning model over time and detects when the model's accuracy or behavior changes due to changes in the data or the task. The drift detection system 202 can help identify when the deployed model needs to be updated or retrained (or triggered for human-AI collaboration workflow) to maintain its performance and reliability.

The drift detection system 202 operates by comparing the current data or model outputs with a reference data or model outputs, such as the data or model used for training. The system can use various statistical tests or metrics to measure the difference or similarity between the current and reference data or outputs, and determine if there is a significant change that indicates drift. For example, the drift detection system 202 can use a test to compare the distributions of the current and reference data, or use an accuracy score to compare the current and reference model outputs.

The drift detection system 202 may be unsure of a novel trend if the change in the data or the task is subtle, gradual, or ambiguous. For example, if the data distribution changes slowly over time, or if there are multiple possible explanations for the change, such as noise, outliers, or concept drift, the drift detection system 202 may not be able to confidently detect or identify the drift. In such cases, the system may need additional information or feedback from other sources, such as domain experts, users, or other models, to verify or clarify the novel trend.

In the example where the drift detection system 202 is unsure of what the novel trend represents. The drift detection system 202 first assesses whether this trend is still a representation of the same class and the data has drifted. For example, the drift detection system 202 uses automated drift detection, in particular, covariate shift detection.

If the drift detection system 202's confidence score is low on its prediction (e.g., below of a predefined threshold score), the drift detection system 202 requests the human-AI collaboration system 206 to prompt users to label the data. As such, the drift detection system 202 detects whether an emerging cluster represents an entirely new class. In one example, the drift detection system 202 dynamically generates label suggestions based on metadata.

The human-AI collaboration system 206 interrogates human users (e.g., end user, or customer at client device 106) via multi-agent system 208 for the human users to verify (label) what the trend is. In one example, the data points labelled by the humans include a ‘confidence score’. The human-AI collaboration system 206 defines a threshold for consensus. The multi-agent system 208 communicates with the client device 106 to query validation from different sets of users.

In one example, the multi-agent system 208 comprises a combination of user agents, AI agents, multi-agents, and adjacent agents:
User agents—These are human users that interact with and provide input to the system, such as domain experts, end users, customers, underwriters, etc. They provide labels, validation, and feedback to help the system learn.
AI agents—These are the AI/machine learning models and algorithms that make up the core of the system. The main deployed model detects trends and patterns. Other AI agents may be created later via transfer learning to perform related tasks.
Multi-agent system—This is a group of interconnected agents, both human and AI, that work together to augment the system's capabilities. It facilitates collaboration between different users and models.
Adjacent user agents—These are users from teams working on related problems or domains that could benefit from the insights of the models. The system suggests deploying the models to adjacent users. The following illustrates examples of adjacent users:

In an insurance company, adjacent users could be from the claims, pricing, fraud, or risk assessment teams. The insights from models trained to detect certain driver behaviors could be useful for their work too.

In a bank, adjacent users could be from the credit risk, anti-money laundering, or customer retention teams. Models trained to detect financial fraud could provide value to their objectives.

In a healthcare system, adjacent users could be from patient care, billing, or population health management teams. Models trained to predict disease risks could inform their decision-making.

In retail, adjacent users could be from the marketing, supply chain, or customer analytics teams. Models trained to understand customer behavior could assist their functions.

In general, any users working on related business problems, trying to understand similar phenomena, or working with correlated data sources could be considered adjacent users that may benefit from the transfer learning capabilities of the system.

The meta-learning via transfer learning module 204 requests the machine learning platform 122 to generate a newly trained model based the responses from the users via multi-agent system 208 and human-AI collaboration system 206. The automated monitoring system 210 assesses the performance of this new model based on sensible performance metrics. For example, a ‘better than random’ score, and F1 score, are important industry standard metrics for a classification problem, and this constitutes ‘sensible’ choices. Only if these performance metrics are satisfied, does the additional model (newly trained model) deploy alongside the existing model. In another example, the newly trained model replaces the existing model.

The continuous meta-learning system 126 captures various versions of the new model to ensure that changes made with new data inputs can be managed and tracked. The multi-agent system 208 can propose this new insight and information within a model to adjacent human users. For example, the multi-agent system 208 identifies “adjacent” teams, and members of the team can decide whether this new information would be useful and relevant to their problems. The term “adjacent team” used herein refers to a group of users working within a same organization as the model users (who also benefit from consuming these model predictions). For example, in an insurance organization, some models used and validated by the Underwriting team may also be of use to the adjacent Claims and Pricing teams.

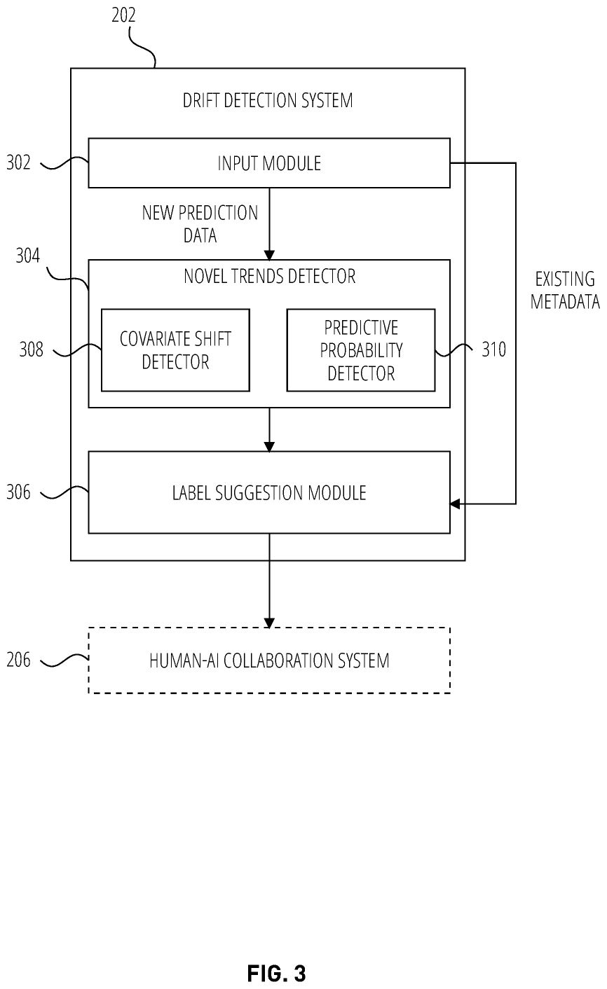

FIG. 3 illustrates the drift detection system 202 in accordance with one example embodiment. The drift detection system 202 includes an input module 302, a novel trends detector 304, a label suggestion module 306, a covariate shift detector 308, and a predictive probability detector 310. The input module 302 accesses the deployed model, metadata, new prediction data from the machine learning platform 122. The input module 302 provides the new prediction data to the novel trends detector 304.

The continuous meta-learning system 126 determines when to query experts versus adapting automatically by relying on the drift detection system 202 to identify when human input is needed. The drift detection system 202 uses techniques like covariate shift detection and predictive probability analysis to flag potential novel trends. If the confidence scores from these drift detection methods are high, the system can adapt automatically via transfer learning without human verification. Confidence thresholds would be set to determine what is considered “high” based on the use case. When confidence scores are below the preset thresholds, this indicates uncertainty about the potential trend. In these cases, the system cannot confidently adapt on its own, so it engages the human-AI collaboration system 206 module. The human-AI collaboration system 206 generates label suggestions using metadata and queries domain experts to verify the uncertain trend. It gathers responses and determines consensus based on the rate of confirmations received. If consensus is achieved, this provides the confirmation needed for the system to proceed with adapting through transfer learning. Lack of consensus would indicate no adaptation is necessary. Additionally, after retraining, the monitoring module evaluates the performance of the adapted model. If it fails to exceed the expected performance thresholds, the system again requests more labels from experts to improve the model. In essence, the system relies on confidence scores and consensus achievement to determine whether human confirmation is required before adapting to a detected trend. Preset thresholds on confidence and consensus rates help make this an automated decision process. So in summary, the system leverages uncertainty-aware drift detection and flexible human collaboration to determine when adaptation can be automated vs. when experts are needed to guide adaptation and provide oversight.

The input module 302 receives the new prediction data as well as existing metadata associated with the deployed model. It passes the new prediction data to the novel trends detector 304. The novel trends detector 304 analyzes the new prediction data to detect any potential novel trends the model was not originally trained to recognize. It contains two sub-Components:
The covariate shift detector 308 specifically looks for shifts in the input data distribution that may indicate a novel trend. It operates by comparing the new data to reference data used to train the original model.
The predictive probability detector 310 looks for areas of high uncertainty in the model's predictions on the new data. Uncertainty can imply novelty that the model is unfamiliar with.

If the analysis by the novel trends detector 304 suggests a potential trend but there is low confidence, the label suggestion module 306 is activated. This module generates label suggestions for the uncertain trend based on an analysis of metadata related to the deployed model.

The label suggestions are passed to the human-AI collaboration system 206 which queries domain experts to verify whether the trend is real and properly labeled. Their confirmation provides the feedback needed for the drift detection system 202 to adapt the model appropriately. As such, the drift detection system 202 leverages automated trend detection and uncertainty analysis to determine when human verification is needed from domain experts before adapting the model.

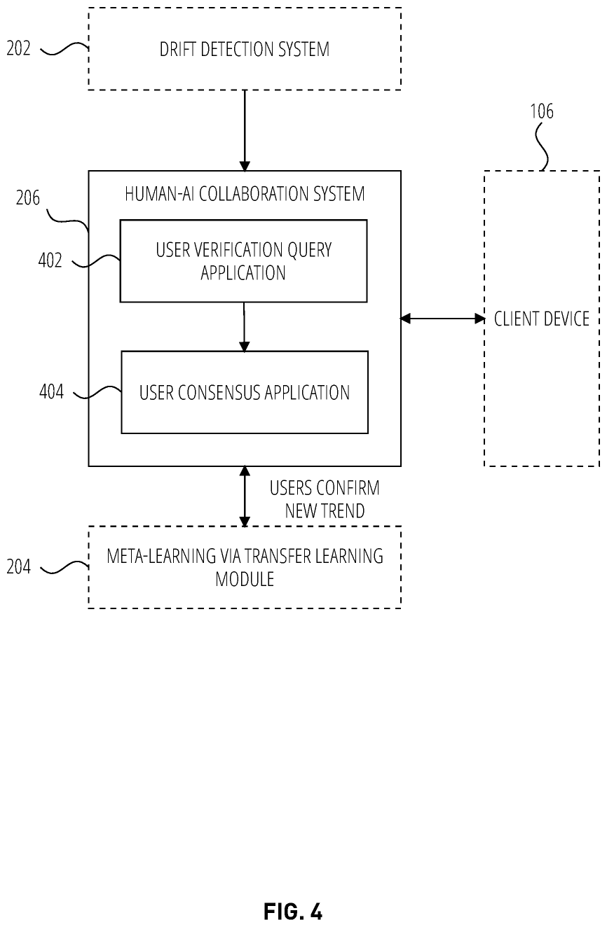

FIG. 4 illustrates the human-AI collaboration system 206 in accordance with one example embodiment. The drift detection system 202 requests the human-AI collaboration system 206 to query the users in response to detecting a new trend.

The human-AI collaboration system 206 includes a user verification query application 402 and a user consensus application 404. The user verification query application 402 communicates with the client device 106 of the users to query suggestions for the labels. In another example, the user verification query application 402 communicates with the client device 106 of the users to provide candidate labels for the users to validate.

In other examples, the user verification query application 402 queries domain experts to verify a novel trend by using one or more of the following methods:
Asking the domain experts to label some data points that are suspected to belong to the novel trend, and comparing their labels with the model's predictions.
Asking the domain experts to provide explanations or justifications for why the data points belong to the novel trend, and checking if their explanations match the model's assumptions or expectations.
Asking the domain experts to rate or rank the model's predictions for the data points that belong to the novel trend, and measuring the agreement or disagreement between the experts and the model.
Asking the domain experts to suggest or recommend actions or interventions that can be taken to address or adapt to the novel trend, and evaluating the feasibility or effectiveness of their suggestions.

Some benefits of the user verification query application 402 querying domain experts include:
The domain experts can provide valuable insights or knowledge that the model may not have access to or may not be able to learn from the data alone.
The domain experts can help the model overcome uncertainty or ambiguity in the data or the task, and improve its confidence or reliability.
The domain experts can help the model detect or correct errors or biases that may affect its performance or behavior.
The domain experts can help the model learn from their feedback and improve its adaptability or generalization.A domain expert is someone who has specialized knowledge or expertise in a particular field or domain.

Some examples of domain experts include:
Insurance underwriters—Experts in assessing insurance risk profiles and coverage needs. They could provide feedback on detecting new driving behaviors.
Doctors—Experts in diagnosing and treating health conditions. They could verify predictions of disease risks.
Fraud investigators—Experts in identifying financial crimes. They could validate models detecting fraud patterns.
Auto mechanics—Experts in vehicle repair and maintenance. They could label data on driving patterns and car issues.
Academics—Experts in a scholarly field through research and teaching. They could provide insights on relevant scientific concepts.
Engineers—Experts in technical fields like software, manufacturing, etc. They could guide modeling of complex systems.
Lawyers—Experts in the law. They could ensure models follow regulations and ethical guidelines.
Data scientists—Experts in machine learning methods. They could optimize model training and evaluation.

In general, domain experts have specialized skills and knowledge from experience in their field that can provide useful human guidance, validation, and oversight to AI systems being developed in that problem area. Their expertise can help improve and contextualize the machine learning.

The user consensus application 404 receives responses from the client device 106 and determines a consensus among the users. For example, the consensus from the users indicates a validation/confirmation of the new trend. In another example, the consensus from the users indicates a confirmation of the new labels. The user consensus application 404 communicates the confirmation/validation of the new trend to the meta-learning via transfer learning module 204.

Assessing consensus from domain experts can help the drift detection system 202 evaluate the validity or reliability of the feedback, and resolve any conflicts or discrepancies among the experts. In some examples, the user consensus application 404 assesses consensus from domain experts/users by:
Using statistical measures such as mean, median, mode, standard deviation, variance, or interquartile range to summarize and compare the feedback from different experts.
Using agreement measures such as Cohen's kappa, Fleiss' kappa, Krippendorff's alpha, or percentage agreement to quantify the similarity or dissimilarity of the feedback from different experts.
Using clustering techniques such as k-means, hierarchical clustering, or spectral clustering to group the feedback from different experts based on their similarity or dissimilarity.
Using voting techniques such as majority voting, plurality voting, weighted voting, or rank aggregation to aggregate the feedback from different experts and select the most popular or preferred option.

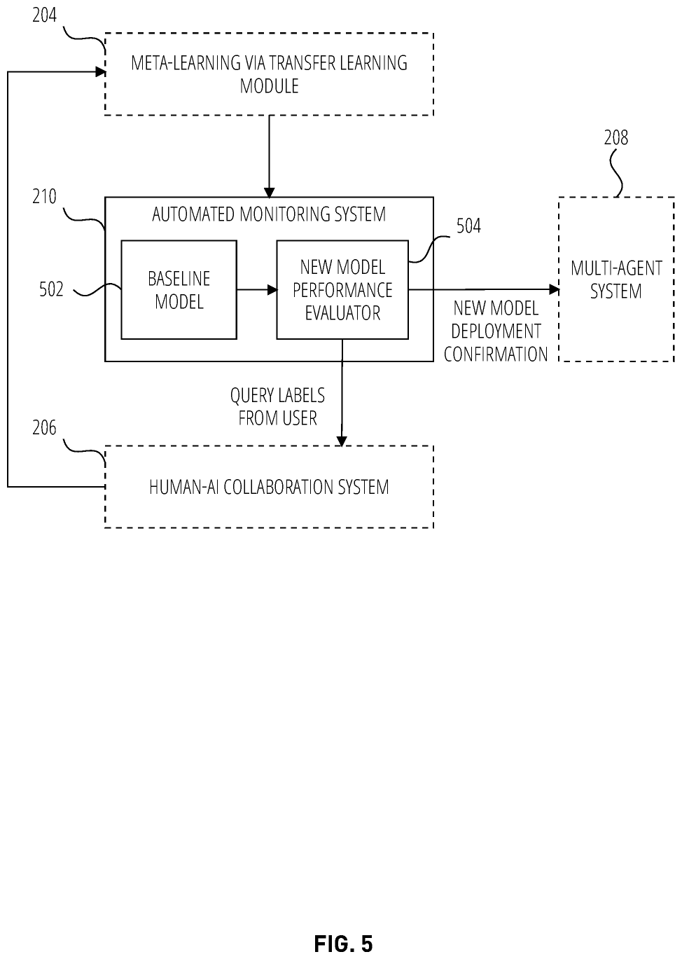

FIG. 5 illustrates the automated monitoring system 210 in accordance with one example embodiment. The automated monitoring system 210 includes a baseline model 502 and a new model performance evaluator 504. The baseline model 502 is based on the deployed trained machine learning model from machine learning platform 122.

The new model performance evaluator 504 assesses a performance of the new model based on the new labels. The new model performance evaluator 504 can help determine if the new model can generalize or adapt to new tasks or domains, and identify any gaps or limitations in the new model's capabilities. Example ways the new model performance evaluator 504 operates to assess the performance of the new machine learning model based on new labels include:
Defining the performance metrics and criteria that are relevant and meaningful for the new task or domain, such as accuracy, precision, recall, F1-score, AUC, RMSE, MAE, etc.
Collecting and labeling the data that has the new labels, and ensuring that the data is representative and sufficient for the new task or domain.
Applying the new machine learning model to the data with the new labels, and generating predictions or outputs for the data.
Calculating and visualizing the performance metrics using the predictions or outputs and the ground truth labels, and comparing them with the baseline or target values.
Analyzing and interpreting the performance metrics and identify any strengths or weaknesses of the new machine learning model on the data with the new labels.

In another example, the new model performance evaluator 504 communicates with the human-AI collaboration system 206 to query the users for confirmation/validation of new trends/labels. Once the performance of the new model satisfies a preset threshold (e.g., a ‘better than random’ score, or another pre-specified value for metrics such as an F1 score), the new model performance evaluator 504 requests the multi-agent system 208 to confirm deployment of the new model. Once the performance of the new model satisfies the preset threshold, the new model performance evaluator 504 requests the machine learning platform 122 to deploy the new model.

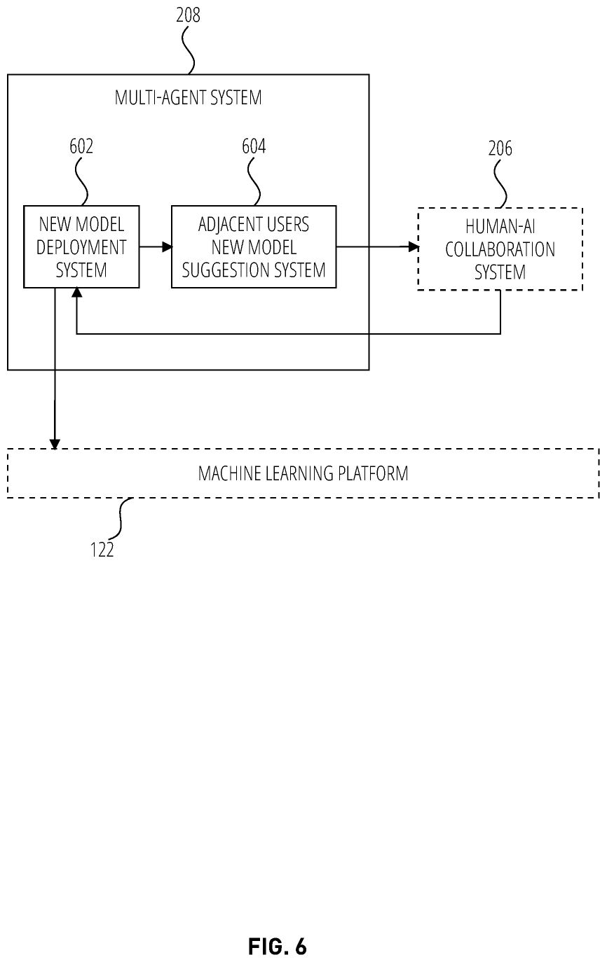

FIG. 6 illustrates the multi-agent system 208 in accordance with one example embodiment. The multi-agent system 208 facilitates collaboration between human users and AI agents to propagate new knowledge discovered by the models.

The new model deployment system 602 is responsible for deploying adapted models that have been retrained based on new trends validated by human consensus. Once the performance of the adapted model meets preset criteria, this system requests deployment of the model.

The adjacent users new model suggestion system 604 looks for opportunities to transfer the knowledge in the adapted model to other users working on related problems. It identifies adjacent users who could benefit from the model's new capabilities.

For example, if claims adjusters, pricing analysts, and underwriters are all working with similar data in an insurance company, an adapted model from the underwriting team could provide value to the other groups.

This adjacent users new model suggestion system 604 leverages the human-AI collaboration system 206 to efficiently query the adjacent users and determine if the adapted model's new knowledge would be useful to them. If consensus indicates it is valuable, the model can be seamlessly deployed to them via transfer learning, propagating the new insights more broadly.

In essence, the multi-agent system 208 enables both the initial deployment of adapted models as well as transfer of those models to adjacent human users who can benefit from the new learning and capabilities. The human-AI collaboration system 206 is utilized to gather human feedback for both processes when needed.

As such, the multi-agent system 208 facilitates efficient collaboration between humans and AI to selectively deploy adapted models within an organization based on where the new knowledge will provide the most value.

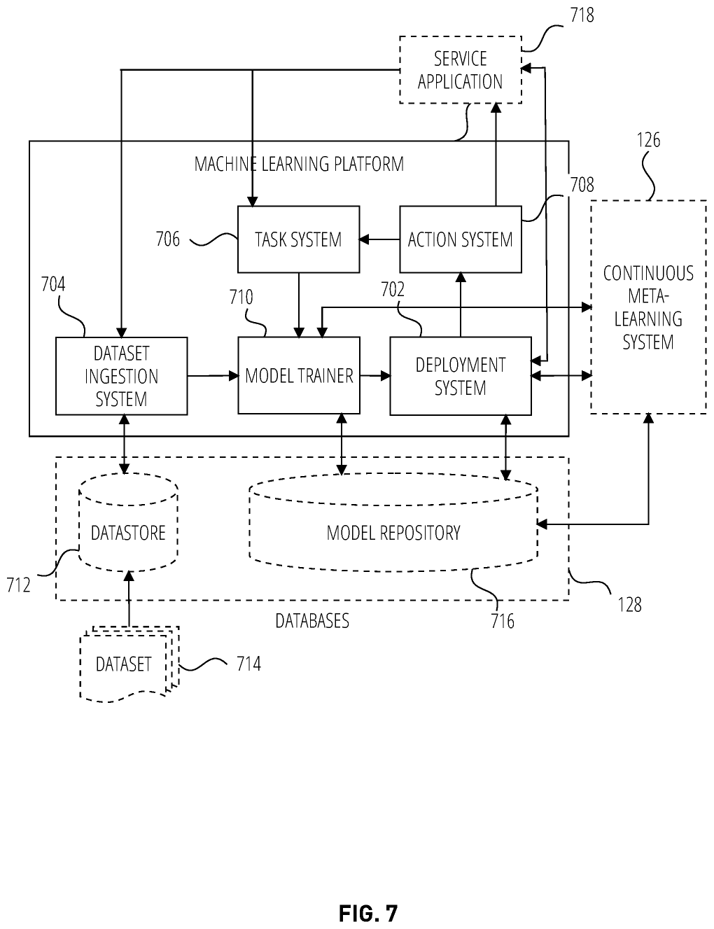

FIG. 7 illustrates a machine learning platform 122 in accordance with one example embodiment. The machine learning platform 122 includes a dataset ingestion system 704, a model trainer 710, a deployment system 702, a continuous meta-learning system 126, a task system 706, an action system 708.

The dataset ingestion system 704 acquires training data for the model trainer 710 from a datastore 712 at the databases 128. The datastore 712 includes a dataset provided by the client device 106, the service application 718, or the third-party application 114. In one example embodiment, the dataset ingestion system 704 annotates the training data with statistical properties (e.g., mean, variance, n-ordered differences) and tags (e.g., parts of speech for words in the text data, days of week for date-time values, anomaly flagging for continuous data). In another example embodiment, the dataset ingestion system 704 analyzes the training data and determines whether additional training data (relevant or complimentary to the training data) are available to further augment the training data. In one example, the dataset ingestion system 704 requests the client device 106 to provide additional data. In another example, the dataset ingestion system 704 accesses a library of datasets in the datastore 712 and augments the training data with at least one of the dataset from the library of datasets. In yet another example, the dataset ingestion system 704 accesses a marketplace of datasets (e.g., provided by the third-party application 114) to identify a dataset to augment the training data. For example, a data set includes a column of zip codes. The dataset ingestion system 704 identifies the data as zip codes and offers to augment the data set by adding another dataset such as “mean income” for each zip code from a library of other datasets (e.g., latitude, longitude, elevation, weather factors, social factor).

In another example embodiment, the dataset ingestion system 704 includes an advisor feature that advises the client device 106 (that provides the dataset 714) on how to prepare the dataset 714 for processing by the model trainer 710. For example, the dataset ingestion system 704 analyzes a structure of the dataset 714 and advises the client device 106 that the dataset contains missing values that should be amended before processing by the model trainer 710. In one example, the dataset ingestion system 704 estimates the missing values based on approximation.

The task system 706 defines a task for the model trainer 710. For example, the task identifies parameters of a goal (e.g., problem to be solved, target column, data validation and testing method, scoring metric). The task system 706 receives a definition of the task from the client device 106, the service application 718, or the third-party application 114. In another example, the task system 706 receives an updated task from the action system 708. The task system 706 can also define non-machine learning tasks, such as data transformations and analysis.

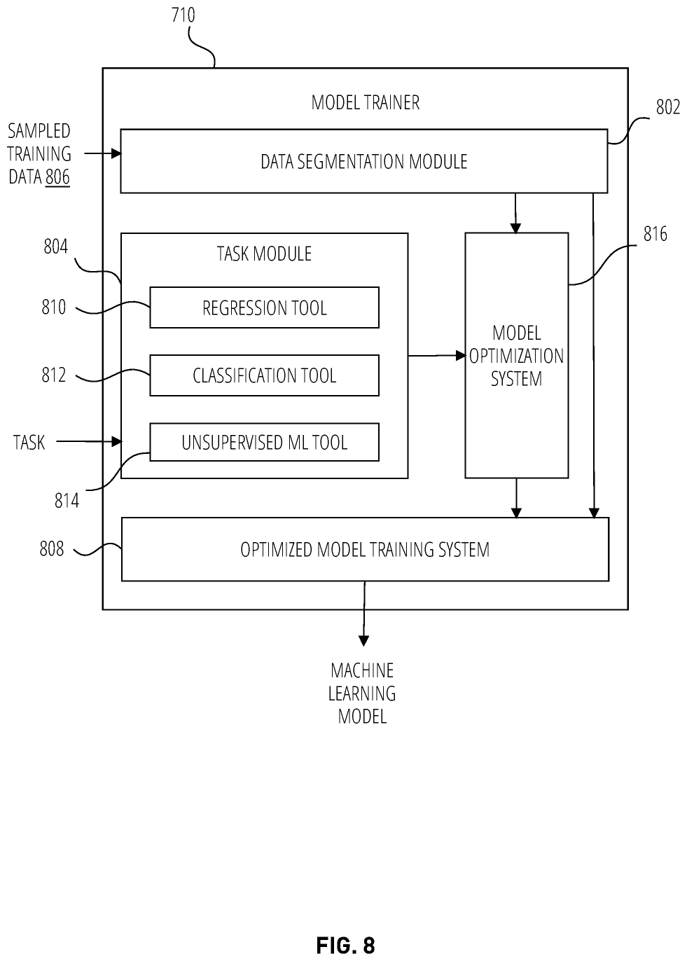

The model trainer 710 uses a machine learning algorithm to train a machine learning model based on the data from the dataset ingestion system 704 and the task from the task system 706. In one example, the model trainer 710 forms and optimizes a machine learning model to solve the task defined in the task system 706. Example embodiments of the model trainer 710 are described further below with respect to FIG. 8.

The deployment system 702 includes a deployment engine (not shown) that deploys the machine learning model to other applications (that are external to the machine learning platform 122). For example, the deployment system 702 provisions an infrastructure such that the machine learning model may exist in a query-able setting and be used to make predictions upon request. An example of a deployment includes uploading of the machine learning model or parameters to replicate such a model to the deployment system 702, such that the deployment system 702 may then support the machine learning model and expose the relevant functionalities.

In another example, the deployment system 702 enables the service application 718 to access and use the machine learning model to generate forecasts and predictions on new data. The deployment system 702 stores the model in a model repository 716 of the databases 128.

The continuous meta-learning system 126 tests and assesses a performance of the machine learning model (from the deployment system 702). For example, the continuous meta-learning system 126 runs tests and benchmarks on a model to assess its algorithmic and computational performance and facilitate comparison with other models. In another example, the continuous meta-learning system 126 may receive validation of the quality or performance from a user of the client device 106. In yet another example, the continuous meta-learning system 126 includes tracking model usage, monitoring performance, and allowing the model to make predictions and take actions based on arbitrary triggers rather than simply API calls from other services.

In another example, the deployment system 702 enables the service application 718 to access and use the machine learning model to generate forecasts and predictions on new data. In another example, the deployment system 702 stores the model in a model repository 716 of the databases 128.

The action system 708 triggers an external action (e.g., a call to the service application 718) based predefined conditions. For example, the action system 708 detects that the deployment system 702 has deployed the machine learning model. In response to detecting the deployment of the machine learning model, the action system 708 notifies the service application 718 (e.g., by generating and communicating an alert of the deployment to the service application 718). Other examples of actions from the action system 708 include retraining of the machine learning model, updating of model parameters, stopping the model functioning if performance is below a threshold (failsafe feature), communicating (via email/text/messaging platform) alerts based on performance or usage.

The continuous meta-learning system 126 monitors the deployment of the machine learning model. For example, the continuous meta-learning system 126 continuously monitors a performance of the machine learning model (used by the service application 718) and provides a feedback to the dataset ingestion system 704 and the task system 706 via the action system 708. For example, the service application 718 provides an updated task to the task system 706 and latest data to the dataset ingestion system 704. This process may be referred to as meta learning. In another example, the continuous meta-learning system 126 may also monitor characteristics of the data such as frequency of missing values or outliers, and employ different strategies to remedy these issues. The continuous meta-learning system 126 thus refines which strategies to use for a given situation by learning which strategy is most effective.

In one example embodiment, the continuous meta-learning system 126 monitors a performance of the machine learning model. For example, the continuous meta-learning system 126 intermittently assesses the performance of the machine learning model as new data comes in, such that an updated score can be derived representing the model's most recent performance. In another example, the continuous meta-learning system 126 quantifies and monitors the sensitivity of the machine learning model to noise by perturbing the data and assessing the impact on model scores/predictions. After updating a machine learning model, the continuous meta-learning system 126 may also test the machine learning model on a set of holdout data to ensure it is appropriate for deployment (e.g., by comparing the performance of a new model to the performance of previous models). Model performance can also be quantified in terms of compute time and required resources such that if the frequency or type of data being ingested changes causing a drop in efficiency or speed, the user may be alerted to this.

The continuous meta-learning system 126 determines whether the performance/accuracy of the machine learning model is acceptable (e.g., above a threshold score). If the continuous meta-learning system 126 determines that the performance/accuracy of the machine learning model is no longer acceptable, the action system 708 redefines the task at the task system 706 or suggests changes to the training data at dataset ingestion system 704. For example, if performance is no longer acceptable, the action system 708 raises an alert to the user 130 through communication means (e.g., email/text), and provide suggestions of the cause of the problem and remedial steps. The action system 708 can also update the model based on the latest data or stop the model from making predictions. In another example embodiment, these action behaviors may be defined by the user in an “if this then that” fashion.

FIG. 8 illustrates a model trainer 710 in accordance with another example embodiment. The model trainer 710 includes a data segmentation module 802, a task module 804, a model optimization system 816, and an optimized model training system. The data segmentation module 802 receives sampled training data 806. The data segmentation module 802 summarizes the data. For example, data is summarized by calculating summary statistics and describing the sample's distribution. Continuous values are binned and counted. Outliers and anomalies are flagged. The data segmentation module 802 further slices the summarized data into data slices such that a mathematical definition of information contained in the original data is equally distributed between the data slices. This is achieved by stratification of data partitions; ensuring that the data distributions between slices are as closely matched as possible. The data segmentation module 802 provides the data slices to the model optimization system 816.

The client device 106 provides the user-defined task to task module 804. The task module 804 includes different types of machine learning tools: a regression tool 810, a classification tool 812, and an unsupervised ML tool 814. The task module 804 maps the user-defined task to the one of the machine learning tools. For example, if the user-defined task has a goal of predicting a categorical value, the task module 804 would map the task to a classification tool. A goal of predicting a continuous value would be mapped to a regression tool. If the user-defined task is to find underlying groupings within the data, it would be mapped to a clustering (unsupervised ML) tool. In one example, a look up table is defined and provides a mapping between different types of task and a type of machine learning tool.

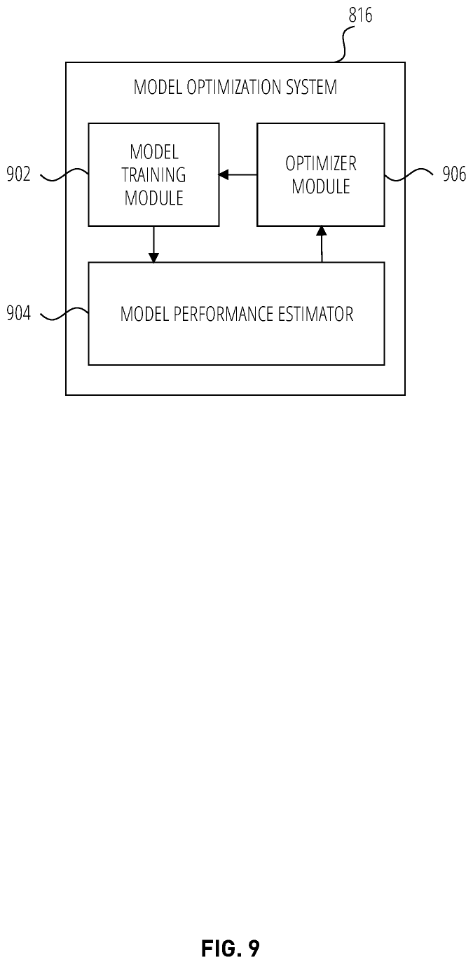

The model optimization system 816 trains a machine learning model based on the data slices and the type of machine learning tool. An example embodiment of the model optimization system 816 is described further below with respect to FIG. 9.

The optimized model training system 808 receives the optimized machine learning model from the model optimization system 816, retrains the model with all available and appropriate data, and provides the trained optimized machine learning model to the client device 106.

FIG. 9 illustrates a model optimization system in accordance with one example embodiment. The model optimization system 816 includes a model training module 902, an optimizer module 906, and a model performance estimator 904. The optimizer module 906 suggests a specific model. The specific model is defined through a set of hyper-parameters. These are a collection of named values, which together fully specify a particular model ready for model fitting on some training data.

The model training module 902 trains the specific model using multiple data subsets. The model performance estimator 904 calculates a score representing the performance of the specific model. The optimizer module 906 receives the score and suggests another specific model based on the score. Given a model as, for example, a random forest, the model is trained using multiple data sets. The performance can be computed using, as an example, a loss function. If the score is below a threshold, the optimizer module 906 will navigate the space of hyper-parameters following, as an example, the gradients of the loss function. A new set of values for the model hyper-parameters will be suggested.

FIG. 10 illustrates an example method 1000 for training a model for continuous meta-learning. Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence.

According to some examples, the method includes accessing deployed model, metadata, new prediction data at block 1002. For example, the AI system has a particular model in production that is focused on detecting delivery drivers.

According to some examples, the method includes detecting novel trend in deployed model at block 1004. The system is able to pick up on a ‘novel’ trend. The system identifies ‘novelty’ by, for example, looking at new and emergent ‘clusters.’ The system is unsure of what the novel trend represents. The system firstly assesses whether this trend is really still a representation of delivery driving and the data has drifted. It does this through automated drift detection, in particular covariate shift detection. In one example, where the system's confidence score is low on its prediction, it prompts a user to label. The system ‘knows’ this emerging cluster may represent an entirely new class of driving.

According to some examples, the method includes generating label suggestions using metadata at block 1006. The system dynamically generates label suggestions based on metadata, which may come from occupation data related to policyholder information.

According to some examples, the method includes querying user for new trend verification at block 1008. The system interrogates human users, in this example, underwriters, for verifying (labelling) what the trend is. The datapoints labelled by the underwriters include a ‘confidence score.’

According to some examples, the method includes detecting user consensus at block 1010. Consensus is used to determine when the system can confidently adapt through transfer learning versus when human feedback is inconsistent.

Consensus is quantified by looking at the rate or proportion of confirming responses from users when queried about a potential new trend or labeling. For example, if 10 domain experts are asked to verify a trend and 7 of them agree it is valid, the 70% consensus rate would likely be sufficient to proceed with model adaptation.

Preset consensus rate thresholds are defined based on the use case requirements. In situations requiring high confidence, the threshold may be set at 90% agreement or more. For other use cases, 60% consensus may be adequate. The system automatically tallies the responses and checks if the rate exceeds the defined threshold to determine whether overall consensus has been achieved.

The human-AI collaboration system 206 can leverage various statistical aggregation techniques to quantify consensus levels. For example, it may use the mode or median of responses if there is a rating scale. It may apply clustering algorithms to group similar responses. Majority voting is a straightforward method for binary yes/no questions. The optimal technique depends on factors like the type of user feedback collected.

In some cases, dissenting user viewpoints are also valuable to capture. The collaboration system can highlight areas of disagreement for further investigation by data scientists. For instance, if 2 users out of 10 disagree with the others, understanding their perspective may uncover additional nuances. The goal is to strike a balance between consensus-driven adaptation and capturing dissenting opinions that may also yield insights.

In summary, the human-AI collaboration system 206 quantifies consensus rates based on aggregating feedback from multiple users to determine when confidence thresholds are met to proceed with automated model adaptation. The techniques used to measure consensus are customizable for different use cases and types of user input.

A threshold for consensus is defined based on the actual case scenario. For example, in the case of auto insurance, the underwriters decide what confidence threshold they would base new classifications. The 206 automatically assesses the performance of this new model based on use case-specific performance metrics.

According to some examples, the method includes training new model via transfer learning at block 1012. If these performance metrics are satisfied, the additional model (car sharing driving detection) deploy alongside the existing model (delivery driving detection).

According to some examples, the method includes deploying new model at block 1014. The system is now capable of performing two similar, but distinct tasks. For example, the model can now ‘understand’ both the behavioral patterns in delivery drivers and car sharing drivers, and distinguish them.

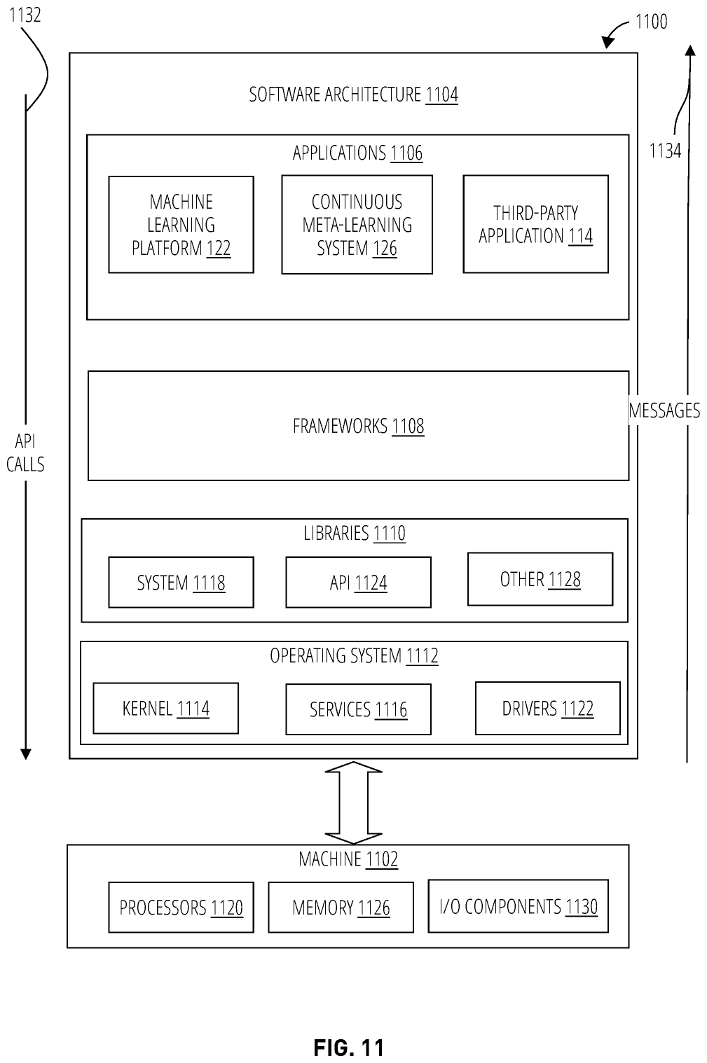

FIG. 11 is a block diagram 1100 illustrating a software architecture 1104, which can be installed on any one or more of the devices described herein. The software architecture 1104 is supported by hardware such as a machine 1102 that includes Processors 1120, memory 1126, and I/O Components 1130. In this example, the software architecture 1104 can be conceptualized as a stack of layers, where each layer provides a particular functionality. The software architecture 1104 includes layers such as an operating system 1112, libraries 1110, frameworks 1108, and applications 1106. Operationally, the applications 1106 invoke API calls 1132 through the software stack and receive messages 1134 in response to the API calls 1132.

The operating system 1112 manages hardware resources and provides common services. The operating system 1112 includes, for example, a kernel 1114, services 1116, and drivers 1122. The kernel 1114 acts as an abstraction layer between the hardware and the other software layers. For example, the kernel 1114 provides memory management, Processor management (e.g., scheduling), Component management, networking, and security settings, among other functionality. The services 1116 can provide other common services for the other software layers. The drivers 1122 are responsible for controlling or interfacing with the underlying hardware. For instance, the drivers 1122 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1110 provide a low-level common infrastructure used by the applications 1106. The libraries 1110 can include system libraries 1118 (e.g., C standard library) that provide functions such as memory allocation functions, string manipulation functions, mathematic functions, and the like. In addition, the libraries 1110 can include API libraries 1124 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1110 can also include a wide variety of other libraries 1128 to provide many other APIs to the applications 1106.

The frameworks 1108 provide a high-level common infrastructure that is used by the applications 1106. For example, the frameworks 1108 provide various graphical user interface (GUI) functions, high-level resource management, and high-level location services. The frameworks 1108 can provide a broad spectrum of other APIs that can be used by the applications 1106, some of which may be specific to a particular operating system or platform.

In an example embodiment, the applications 1106 may include a machine learning platform 122, A continuous meta-learning system 126, and a broad assortment of other applications such as a third-party application 114. The applications 1106 are programs that execute functions defined in the programs. Various programming languages can be employed to create one or more of the applications 1106, structured in a variety of manners, such as object-oriented programming languages (e.g., Objective-C, Java, or C++) or procedural programming languages (e.g., C or assembly language). In a specific example, the third-party application 114 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 114 can invoke the API calls 1132 provided by the operating system 1112 to facilitate functionality described herein.

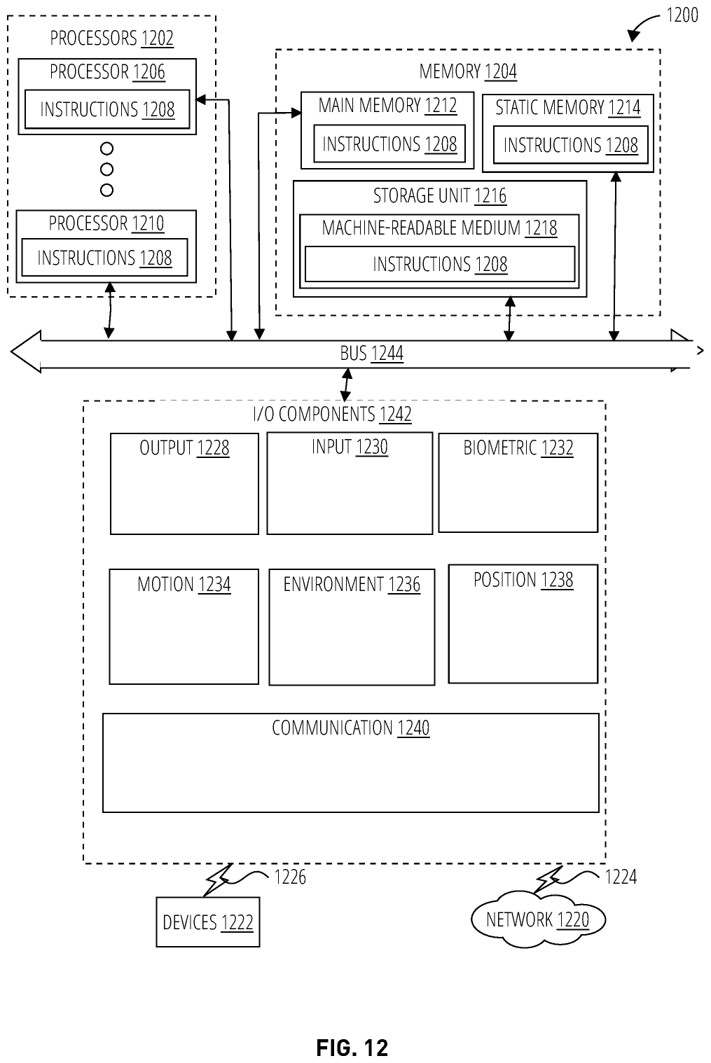

FIG. 12 is a diagrammatic representation of the machine 1200 within which instructions 1208 (e.g., software, a program, an application, an applet, an app, or other executable code) for causing the machine 1200 to perform any one or more of the methodologies discussed herein may be executed. For example, the instructions 1208 may cause the machine 1200 to execute any one or more of the methods described herein. The instructions 1208 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while only a single machine 1200 is illustrated, the term “machine” shall also be taken to include a collection of machines that individually or jointly execute the instructions 1208 to perform any one or more of the methodologies discussed herein.

The machine 1200 may include Processors 1202, memory 1204, and I/O Components 1242, which may be configured to communicate with each other via a bus 1244. In an example embodiment, the Processors 1202 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 1206 and a Processor 1210 that execute the instructions 1208. The term “Processor” is intended to include multi-core Processors that may comprise two or more independent Processors (sometimes referred to as “cores”) that may execute instructions contemporaneously. Although FIG. 12 shows multiple Processors 1202, the machine 1200 may include a single Processor with a single core, a single Processor with multiple cores (e.g., a multi-core Processor), multiple Processors with a single core, multiple Processors with multiples cores, or any combination thereof.

The memory 1204 includes a main memory 1212, a static memory 1214, and a storage unit 1216, both accessible to the Processors 1202 via the bus 1244. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the Processors 1202 (e.g., within the Processor's cache memory), or any suitable combination thereof, during execution thereof by the machine 1200.

The I/O Components 1242 may include a wide variety of Components to receive input, provide output, produce output, transmit information, exchange information, capture measurements, and so on. The specific I/O Components 1242 that are included in a particular machine will depend on the type of machine. For example, portable machines such as mobile phones may include a touch input device or other such input mechanisms, while a headless server machine will likely not include such a touch input device. It will be appreciated that the I/O Components 1242 may include many other Components that are not shown in FIG. 12. In various example embodiments, the I/O Components 1242 may include output Components 1228 and input Components 1230. The output Components 1228 may include visual Components (e.g., a display such as a plasma display panel (PDP), a light emitting diode (LED) display, a liquid crystal display (LCD), a projector, or a cathode ray tube (CRT)), acoustic Components (e.g., speakers), haptic Components (e.g., a vibratory motor, resistance mechanisms), other signal generators, and so forth. The input Components 1230 may include alphanumeric input Components (e.g., a keyboard, a touch screen configured to receive alphanumeric input, a photo-optical keyboard, or other alphanumeric input Components), point-based input Components (e.g., a mouse, a touchpad, a trackball, a joystick, a motion sensor, or another pointing instrument), tactile input Components (e.g., a physical button, a touch screen that provides location and/or force of touches or touch gestures, or other tactile input Components), audio input Components (e.g., a microphone), and the like.

In further example embodiments, the I/O Components 1242 may include biometric Components 1232, motion Components 1234, environmental Components 1236, or position Components 1238, among a wide array of other Components. For example, the biometric Components 1232 include Components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1234 include acceleration sensor Components (e.g., accelerometer), gravitation sensor Components, rotation sensor Components (e.g., gyroscope), and so forth. The environmental Components 1236 include, for example, illumination sensor Components (e.g., photometer), temperature sensor Components (e.g., one or more thermometers that detect ambient temperature), humidity sensor Components, pressure sensor Components (e.g., barometer), acoustic sensor Components (e.g., one or more microphones that detect background noise), proximity sensor Components (e.g., infrared sensors that detect nearby objects), gas sensors (e.g., gas detection sensors to detection concentrations of hazardous gases for safety or to measure pollutants in the atmosphere), or other Components that may provide indications, measurements, or signals corresponding to a surrounding physical environment. The position Components 1238 include location sensor Components (e.g., a GPS receiver Component), altitude sensor Components (e.g., altimeters or barometers that detect air pressure from which altitude may be derived), orientation sensor Components (e.g., magnetometers), and the like.

Communication may be implemented using a wide variety of technologies. The I/O Components 1242 further include communication Components 1240 operable to couple the machine 1200 to a network 1220 or devices 1222 via a coupling 1224 and a coupling 1226, respectively. For example, the communication Components 1240 may include a network interface Component or another suitable device to interface with the network 1220. In further examples, the communication Components 1240 may include wired communication Components, wireless communication Components, cellular communication Components, Near Field Communication (NFC) Components, Bluetooth® Components (e.g., Bluetooth® Low Energy), Wi-Fi® Components, and other communication Components to provide communication via other modalities. The devices 1222 may be another machine or any of a wide variety of peripheral devices (e.g., a peripheral device coupled via a USB).

Moreover, the communication Components 1240 may detect identifiers or include Components operable to detect identifiers. For example, the communication Components 1240 may include Radio Frequency Identification (RFID) tag reader Components, NFC smart tag detection Components, optical reader Components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection Components (e.g., microphones to identify tagged audio signals). In addition, a variety of information may be derived via the communication Components 1240, such as location via Internet Protocol (IP) geolocation, location via Wi-Fi® signal triangulation, location via detecting an NFC beacon signal that may indicate a particular location, and so forth.

The various memories (e.g., memory 1204, main memory 1212, static memory 1214, and/or memory of the Processors 1202) and/or storage unit 1216 may store one or more sets of instructions and data structures (e.g., software) embodying or used by any one or more of the methodologies or functions described herein. These instructions (e.g., the instructions 1208), when executed by Processors 1202, cause various operations to implement the disclosed embodiments.

The instructions 1208 may be transmitted or received over the network 1220, using a transmission medium, via a network interface device (e.g., a network interface Component included in the communication Components 1240) and using any one of a number of well-known transfer protocols (e.g., hypertext transfer protocol (HTTP)). Similarly, the instructions 1208 may be transmitted or received using a transmission medium via the coupling 1226 (e.g., a peer-to-peer coupling) to the devices 1222.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### EXAMPLES

Example 1 is a computer-implemented method comprising: accessing, at a server, a deployed machine learning model, metadata, and new prediction data for the deployed machine learning model; detecting a novel trend in the deployed machine learning model based on the new prediction data; generating label suggestions for the novel trend using metadata; querying a plurality of users to verify the label suggestions; detecting a consensus of the plurality of users, the consensus based on a rate of responses from the plurality of users that confirm the label suggestions; in response to detecting the consensus, training a new machine learning model based on the new prediction data and the consensus of the plurality of users; and deploying the new machine learning model at the server.

In Example 2, the subject matter of Example 1 includes, accessing a performance threshold of the deployed machine learning model; and measuring a performance of the new machine learning model relative to the performance threshold of the deployed machine learning model.

In Example 3, the subject matter of Example 2 includes, detecting that the performance of the new machine learning model does not exceed the performance threshold of the deployed machine learning model; and in response to detecting that the performance of the new machine learning model does not exceed the performance threshold of the deployed machine learning model, querying further labels from at least one of the plurality of users.

In Example 4, the subject matter of Examples 1-3 includes, wherein detecting the novel trend comprises: accessing a use-case specific low-dimensional data embedding of the new prediction data; applying a covariate shift detector to the use-case specific low-dimensional data embedding; detecting emerging unlabeled clusters based on the covariate shift detector; and detecting the novel trend based on the emerging unlabeled clusters.

In Example 5, the subject matter of Examples 1-4 includes, wherein detecting the novel trend comprises: accessing a use case specific low-dimensional data embedding of the new prediction data; identifying areas of high uncertainty based on predictive probability analysis of the use case specific low-dimensional data embedding; and detecting the novel trend based on the areas of high uncertainties.

In Example 6, the subject matter of Examples 1-5 includes, identifying adjacent users of the plurality of users; querying the adjacent users to deploy the new machine learning model in a new context for the adjacent users; and deploying the new machine learning model based on responses from the adjacent users.

In Example 7, the subject matter of Examples 1-6 includes, wherein deploying the new machine learning model comprises replacing the deployed machine learning model with the new machine learning model.

In Example 8, the subject matter of Examples 1-7 includes, wherein deploying the new machine learning model comprising deploying the new machine learning model in addition to the deployed machine learning model.

In Example 9, the subject matter of Examples 1-8 includes, querying the plurality of users whether the novel trend is useful; receiving a usefulness confirmation from at least one of the plurality of users; and detecting a usefulness consensus of the plurality of users, the usefulness consensus based on a rate of responses from the plurality of users that confirm the new trend to be useful.

In Example 10, the subject matter of Examples 1-9 includes, querying the plurality of users whether the new machine learning model is useful to other users; receiving a usefulness confirmation from at least one of the plurality of users; detecting a usefulness consensus of the plurality of users, the usefulness consensus based on a rate of responses from the plurality of users that confirm machine learning model is useful to other users; and in response to detecting the usefulness consensus of the plurality of users, deploying the new machine learning model in a new context.

Example 11 is a computing apparatus comprising: a Processor; and a memory storing instructions that, when executed by the Processor, configure the apparatus to: access, at a server, a deployed machine learning model, metadata, and new prediction data for the deployed machine learning model; detect a novel trend in the deployed machine learning model based on the new prediction data; generate label suggestions for the novel trend using metadata; query a plurality of users to verify the label suggestions; detect a consensus of the plurality of users, the consensus based on a rate of responses from the plurality of users that confirm the label suggestions; in response to detecting the consensus, train a new machine learning model based on the new prediction data and the consensus of the plurality of users; and deploy the new machine learning model at the server.

In Example 12, the subject matter of Example 11 includes, wherein the instructions further configure the apparatus to: access a performance threshold of the deployed machine learning model; and measure a performance of the new machine learning model relative to the performance threshold of the deployed machine learning model.

In Example 13, the subject matter of Example 12 includes, wherein the instructions further configure the apparatus to: detect that the performance of the new machine learning model does not exceed the performance threshold of the deployed machine learning model; and in response to detecting that the performance of the new machine learn model does not exceed the performance threshold of the deployed machine learning model, querying further labels from at least one of the plurality of users.

In Example 14, the subject matter of Examples 11-13 includes, wherein detecting the novel trend comprises: access a use-case specific low-dimensional data embedding of the new prediction data; apply a covariate shift detector to the use-case specific low-dimensional data embedding; detect emerging unlabeled clusters based on the covariate shift detector; and detect the novel trend based on the emerging unlabeled clusters.

In Example 15, the subject matter of Examples 11-14 includes, wherein detecting the novel trend comprises: access a use case specific low-dimensional data embedding of the new prediction data; identify areas of high uncertainty based on predictive probability analysis of the use case specific low-dimensional data embedding; and detect the novel trend based on the areas of high uncertainties.

In Example 16, the subject matter of Examples 11-15 includes, wherein the instructions further configure the apparatus to: identify adjacent users of the plurality of users; query the adjacent users to deploy the new machine learning model in a new context for the adjacent users; and deploy the new machine learning model based on responses from the adjacent users.

In Example 17, the subject matter of Examples 11-16 includes, wherein deploying the new machine learn model comprises replacing the deployed machine learning model with the new machine learning model.

In Example 18, the subject matter of Examples 11-17 includes, wherein deploying the new machine learn model comprising deploying the new machine learning model in addition to the deployed machine learning model.

In Example 19, the subject matter of Examples 11-18 includes, wherein the instructions further configure the apparatus to: query the plurality of users whether the novel trend is useful; receive a usefulness confirmation from at least one of the plurality of users; and detect a usefulness consensus of the plurality of users, the usefulness consensus based on a rate of responses from the plurality of users that confirm the new trend to be useful.

Example 20 is a non-transitory computer-readable storage medium, the computer-readable storage medium including instructions that when executed by a computer, cause the computer to: access, at a server, a deployed machine learning model, metadata, and new prediction data for the deployed machine learning model; detect a novel trend in the deployed machine learning model based on the new prediction data; generate label suggestions for the novel trend using metadata; query a plurality of users to verify the label suggestions; detect a consensus of the plurality of users, the consensus based on a rate of responses from the plurality of users that confirm the label suggestions; in response to detecting the consensus, train a new machine learning model based on the new prediction data and the consensus of the plurality of users; and deploy the new machine learning model at the server.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A computer-implemented method comprising:
accessing, at a server, a deployed machine learning model, metadata, and new prediction data for the deployed machine learning model;
detecting a novel trend in the deployed machine learning model based on the new prediction data;
generating label suggestions for the novel trend using metadata;
querying a plurality of users to verify the label suggestions;
detecting a consensus of the plurality of users, the consensus based on a rate of responses from the plurality of users that confirm the label suggestions;
in response to detecting the consensus, training a new machine learning model based on the new prediction data and the consensus of the plurality of users; and
deploying the new machine learning model at the server.

2. The computer-implemented method of claim 1, further comprising:
accessing a performance threshold of the deployed machine learning model; and
measuring a performance of the new machine learning model relative to the performance threshold of the deployed machine learning model.

3. The computer-implemented method of claim 2, further comprising:
detecting that the performance of the new machine learning model does not exceed the performance threshold of the deployed machine learning model; and
in response to detecting that the performance of the new machine learning model does not exceed the performance threshold of the deployed machine learning model, querying further labels from at least one of the plurality of users.

4. The computer-implemented method of claim 1, wherein detecting the novel trend comprises:
accessing a use-case specific low-dimensional data embedding of the new prediction data;
applying a covariate shift detector to the use-case specific low-dimensional data embedding;
detecting emerging unlabeled clusters based on the covariate shift detector; and
detecting the novel trend based on the emerging unlabeled clusters.

5. The computer-implemented method of claim 1, wherein detecting the novel trend comprises:
accessing a use case specific low-dimensional data embedding of the new prediction data;
identifying areas of high uncertainty based on predictive probability analysis of the use case specific low-dimensional data embedding; and
detecting the novel trend based on the areas of high uncertainties.

6. The computer-implemented method of claim 1, further comprising:
identifying adjacent users of the plurality of users;
querying the adjacent users to deploy the new machine learning model in a new context for the adjacent users; and
deploying the new machine learning model based on responses from the adjacent users.

7. The computer-implemented method of claim 1, wherein deploying the new machine learning model comprises replacing the deployed machine learning model with the new machine learning model.

8. The computer-implemented method of claim 1, wherein deploying the new machine learning model comprising deploying the new machine learning model in addition to the deployed machine learning model.

9. The computer-implemented method of claim 1, further comprising:
querying the plurality of users whether the novel trend is useful;
receiving a usefulness confirmation from at least one of the plurality of users; and
detecting a usefulness consensus of the plurality of users, the usefulness consensus based on a rate of responses from the plurality of users that confirm the new trend to be useful.

10. The computer-implemented method of claim 1, further comprising:
querying the plurality of users whether the new machine learning model is useful to other users;
receiving a usefulness confirmation from at least one of the plurality of users;
detecting a usefulness consensus of the plurality of users, the usefulness consensus based on a rate of responses from the plurality of users that confirm machine learning model is useful to other users; and
in response to detecting the usefulness consensus of the plurality of users, deploying the new machine learning model in a new context.

11. A computing apparatus comprising:
a processor; and
a memory storing instructions that, when executed by the processor, configure the apparatus to:
access, at a server, a deployed machine learning model, metadata, and new prediction data for the deployed machine learning model;
detect a novel trend in the deployed machine learning model based on the new prediction data;
generate label suggestions for the novel trend using metadata;
query a plurality of users to verify the label suggestions;
detect a consensus of the plurality of users, the consensus based on a rate of responses from the plurality of users that confirm the label suggestions;
in response to detecting the consensus, train a new machine learning model based on the new prediction data and the consensus of the plurality of users; and
deploy the new machine learning model at the server.

12. The computing apparatus of claim 11, wherein the instructions further configure the apparatus to:
access a performance threshold of the deployed machine learning model; and
measure a performance of the new machine learning model relative to the performance threshold of the deployed machine learning model.

13. The computing apparatus of claim 12, wherein the instructions further configure the apparatus to:
detect that the performance of the new machine learning model does not exceed the performance threshold of the deployed machine learning model; and
in response to detecting that the performance of the new machine learn model does not exceed the performance threshold of the deployed machine learning model, querying further labels from at least one of the plurality of users.

14. The computing apparatus of claim 11, wherein detecting the novel trend comprises:
access a use-case specific low-dimensional data embedding of the new prediction data;
apply a covariate shift detector to the use-case specific low-dimensional data embedding;
detect emerging unlabeled clusters based on the covariate shift detector; and
detect the novel trend based on the emerging unlabeled clusters.

15. The computing apparatus of claim 11, wherein detecting the novel trend comprises:
access a use case specific low-dimensional data embedding of the new prediction data;
identify areas of high uncertainty based on predictive probability analysis of the use case specific low-dimensional data embedding; and
detect the novel trend based on the areas of high uncertainties.

16. The computing apparatus of claim 11, wherein the instructions further configure the apparatus to:
identify adjacent users of the plurality of users;
query the adjacent users to deploy the new machine learning model in a new context for the adjacent users; and
deploy the new machine learning model based on responses from the adjacent users.

17. The computing apparatus of claim 11, wherein deploying the new machine learn model comprises replacing the deployed machine learning model with the new machine learning model.

18. The computing apparatus of claim 11, wherein deploying the new machine learn model comprising deploying the new machine learning model in addition to the deployed machine learning model.

19. The computing apparatus of claim 11, wherein the instructions further configure the apparatus to:
query the plurality of users whether the novel trend is useful;
receive a usefulness confirmation from at least one of the plurality of users; and
detect a usefulness consensus of the plurality of users, the usefulness consensus based on a rate of responses from the plurality of users that confirm the new trend to be useful.

20. A non-transitory computer-readable storage medium, the computer-readable storage medium including instructions that when executed by a computer, cause the computer to:
access, at a server, a deployed machine learning model, metadata, and new prediction data for the deployed machine learning model;
detect a novel trend in the deployed machine learning model based on the new prediction data;
generate label suggestions for the novel trend using metadata;
query a plurality of users to verify the label suggestions;
detect a consensus of the plurality of users, the consensus based on a rate of responses from the plurality of users that confirm the label suggestions;
in response to detecting the consensus, train a new machine learning model based on the new prediction data and the consensus of the plurality of users; and
deploy the new machine learning model at the server.
